(19) United States
(12) Patent Application Publication
(10) Pub. No.: US 2020/0185981 A1
(43) Pub. Date: Jun. 11, 2020

(54) ELECTRIC MOTOR STATOR AND METHODS OF MANUFACTURE OF SAME

(71) Applicant: Stanislav Pavlovich TEREHIN, Moscow (RU)

(72) Inventor: Stanislav Pavlovich TEREHIN, Moscow (RU)

(21) Appl. No.: 16/616,434

(22) PCT Filed: May 17, 2018
(86) PCT No.: PCT/RU2018/000311

§ 371 Date: Nov. 22, 2019

(30) Foreign Application Priority Data
May 25, 2017 (RU) 2017118249

(51) Int. Cl. H02K 1/14

(52) U.S. Cl. CPC H02K 1/146

(57) ABSTRACT

Stators of electric motors and methods for manufacturing same are described. The stator of the electric motor can comprise a coil assembly, which is made of one or more paralleled inductance coils of a cylindrical type of winding, and a cylindrical magnetic circuit with the poles, which are located at the upper and lower ends of the coil assembly and are performed by means of folding towards each other in order to ensure alternation of their polarity.

### CROSS-REFERENCE TO RELATED APPLICATIONS

This Application is a U.S. National Phase Application of International Application No. PCT/RU2018/000311, filed on May 17, 2018, which claims priority to and the benefit of Russian Application No. 2017118249, filed on May 25, 2017, the entire teachings of which are incorporated herein by reference.

### FIELD

The present disclosure generally relates to methods, system, and apparatus for manufacturing of electric motors with permanent magnets on the rotor.

### BACKGROUND

Existing methods of electric motor stator manufacturing include the use of winding in the form of a coil wound on an annular frame.

### BRIEF SUMMARY

In some aspects, the present disclosure relates to an electric motor stator comprising a coil unit comprising one or more cylindrical winding type inductors connected in parallel, and a cylindrical magnetic core with poles located at the upper and lower ends of the coil unit and bent towards each other to ensure alternating polarity, different in that the magnetic core with poles is comprising an electrical steel strip bent into a tube on which the specified coil unit is placed, the winding of which done either on the frame or directly on the tube, with poles made on its both sides in the form of alternating protrusions and depressions, so that the depression on one side is formed opposite to the pole from the other side.

In other aspects, the present disclosure relates to manufacturing method for electric motor stator, comprising a coil assembly comprising one or more cylindrical winding type inductors connected in parallel, and a cylindrical magnetic core with poles that are located on the upper and lower ends of the coil assembly and are made by bending towards each other, different in that the magnetic core with poles is made from a blank in the form of an electrical steel strip, on both sides of which poles are cut in the form of alternating protrusions and depressions, so that the depression on one side is formed opposite to the pole from the other side, then the blank is bent into a tube, which is mounted on the coil assembly wound on the frame, then the magnetic poles are bent towards each other.

In yet other aspects, the present disclosure relates to a manufacturing method for electric motor stator, comprising a coil assembly comprising one or more cylindrical winding type inductors connected in parallel, a cylindrical magnetic core with poles that are located on the upper and lower ends of the coil assembly and are made by bending towards each other, different in that the magnetic core with poles is made from a blank in the form of electrical steel strip, on both sides of which poles are cut in the form of alternating protrusions and depressions, so that the depression on one side is formed opposite to the pole from the other side, then the blank is bent into a tube, the poles of the magnetic core are bent towards each other, then the coil assembly is wound onto a cylindrical magnetic core, and the poles are again bent.

### BRIEF DESCRIPTION OF THE DRAWINGS

FIGS. 1a-1b depict top views and section views of a magnetic core according to embodiments disclosed herein; and

FIGS. 2-21 depict stages of manufacture process according to embodiments disclosed herein.

### DETAILED DESCRIPTION

The present disclosure refers to electrical engineering and can be used for manufacturing of electric motors with permanent magnets on the rotor. There exists a known method of electric motor stator manufacturing with winding in the form of a coil wound on an annular frame. The stator magnetic core can be made in the form of disks mounted respectively on the upper and lower ends, with central holes and the middle part connecting them, which can be installed inside the annular frame of the winding coil. The poles of the stator magnetic core are made by uniformly cutting along the periphery of these disks and bending at an angle of 90° towards each other with alternation, ensuring their alternating polarity (as described in U.S. Pat. No. 5,952,760, the entire teachings of which is incorporated herein by reference).

The disadvantage of this electric motor stator manufacturing method can be the difficulty of manufacturing a magnetic core in three parts. For example, a method of electric motor stator manufacturing can contain a winding in the form of a coil wound on an annular frame. The stator magnetic core can be made in the form of a disk with a central hole. The poles of the magnetic core can be obtained by uniformly cutting alternating poles of different lengths along the periphery of the indicated disk. Long poles are bent twice at an angle of 90°. Moreover, their length can be chosen so that their middle sections form part of the magnetic core for placement inside the coil frame. In this case, short cut poles with the middle part of the magnetic core disk are placed on the upper end of the winding coil, and poles formed by the bent ends of the indicated disk are placed on the lower end of the winding. Moreover, these poles can alternate with each other, as well as their polarity (as described in U.S. Pat. No. 5,859,487, the entire teachings of which is incorporated herein by reference). One other disadvantage of the known magnetic core can be the complexity of manufacturing.

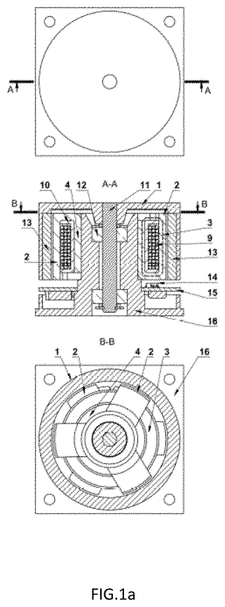

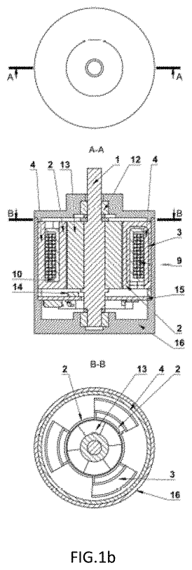

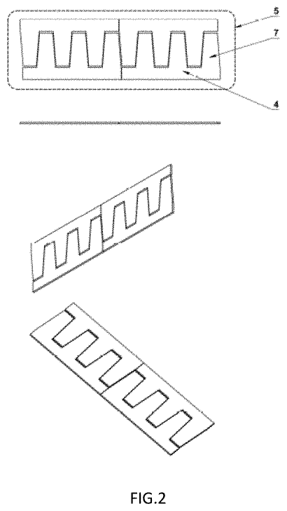

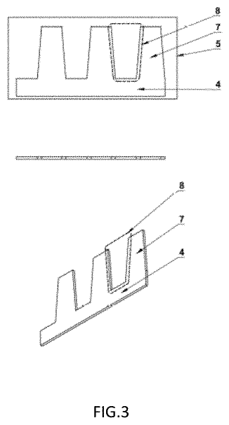

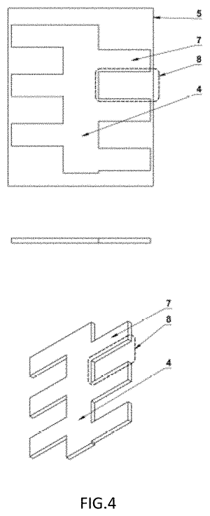

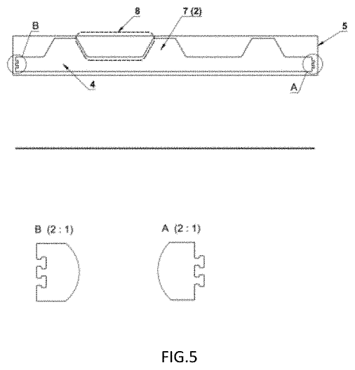

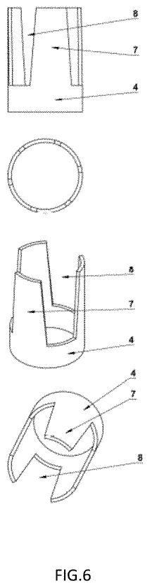

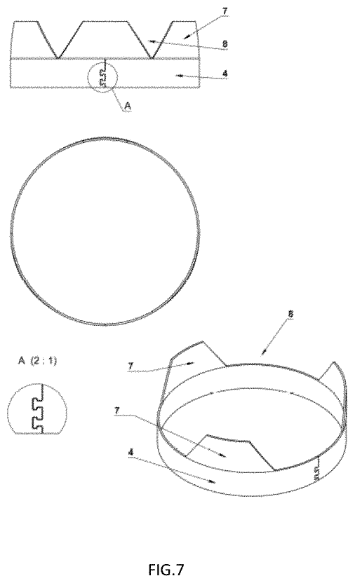

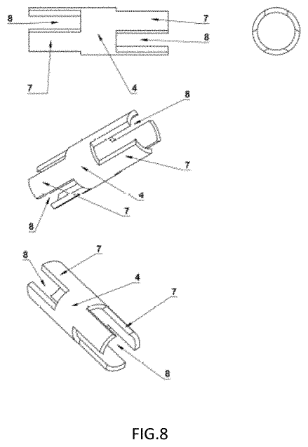

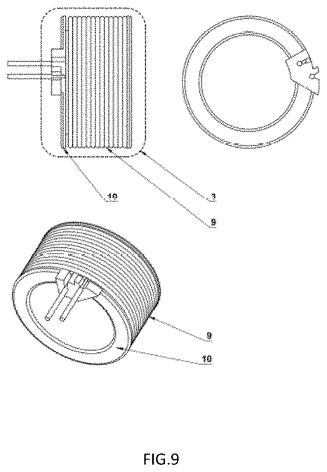

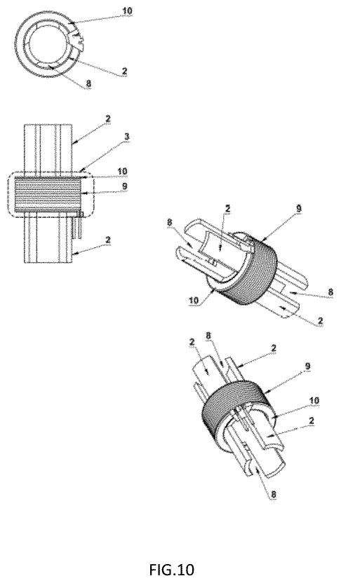

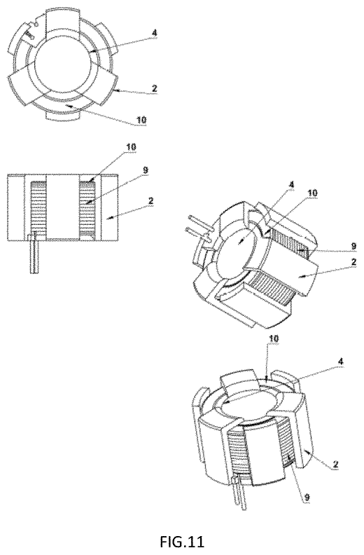

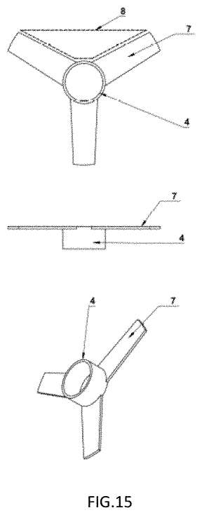

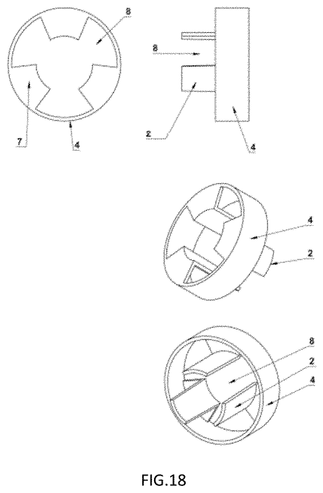

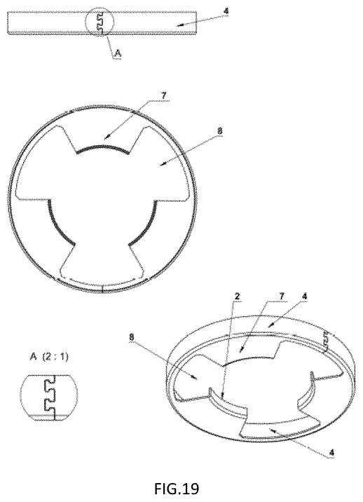

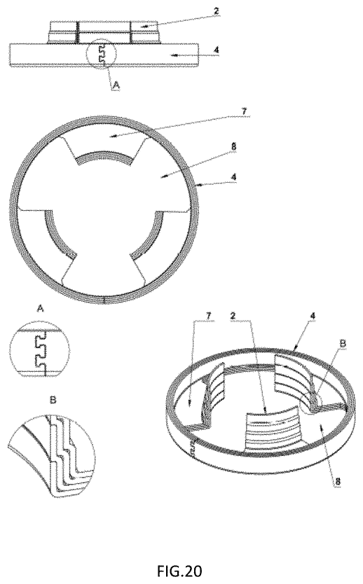

The present disclosure can simplify the manufacture process and increase the efficiency. The implementation of the magnetic core with poles from one single strip of electrical steel can provide increased efficiency, reduce the number of parts and assembly operations, scales down production size and costs. On FIG. 1b and FIG. 1b there shown top views and section views of the claimed magnetic core, FIGS. 2-21 show stages of its manufacture process. The stator of the electric motor comprises a coil unit #3 made of one or more cylindrical winding type inductors connected in parallel, and a cylindrical magnetic core #4 with poles #2 located at the upper and lower ends of the coil unit #3 and bended along the side surface of the coil unit #3 towards each other, forming an alternation of the polarities of the poles for interaction with the poles alternating N and S of the rotor #1 of the electric motor. The magnetic core with the poles is made of a blank in the form of an electrical steel strip #5 bent into a tube (FIGS.6-8), on which the specified coil unit #3 is mounted, the winding is made either on the frame or directly on the tube, on its both sides poles #2 are made in the form of alternating protrusions #7 and depressions #8, so that the depression on one side is formed opposite to the pole from the other side. (FIGS. 2-5). The blank of the magnetic core #4 (FIGS.2-5) in the form of a strip is bent into a tube, with its ends fastened. Then, a coil unit #3 (wound on the frame) is mounted, after which the poles #2 of the magnetic core are bent towards each other.

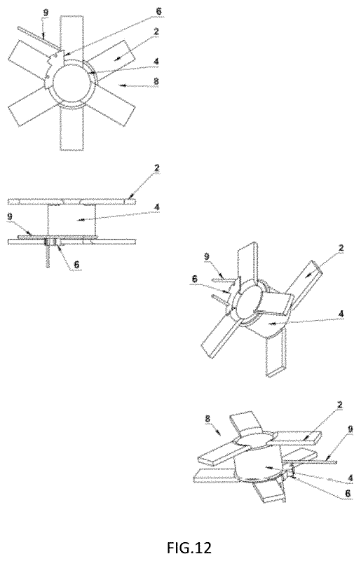

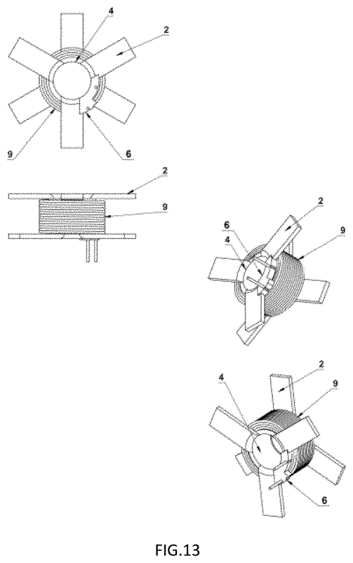

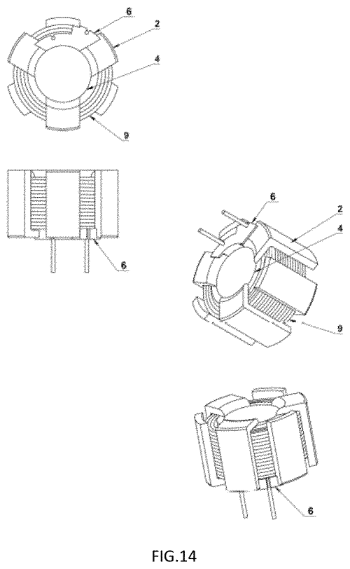

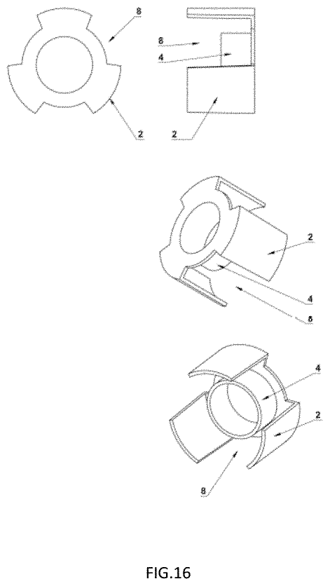

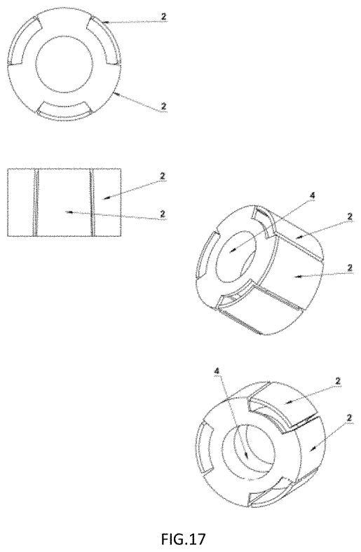

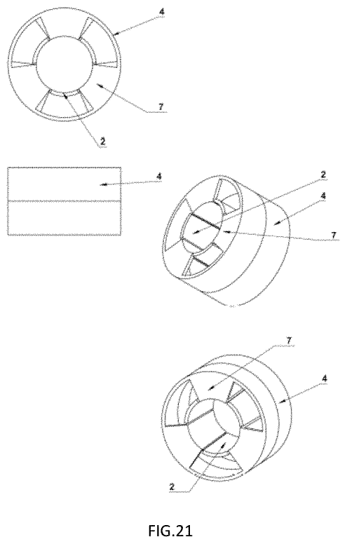

The winding of the coil unit #3 may be carried out directly on the cylindrical part of the magnetic core (FIGS.12-14). The outputs of the coil unit #3 are fixed in the flexible sleeve #6, placed on the magnetic core #4 (FIGS.13-14). The stator can be made of two or more parts of the magnetic core with the formation of a profile, as in FIGS. 17, 21; for example, of two parts, as in FIGS. 16, 18, 20, with guiding elements for assembly in a strictly defined position and fixation in the form of protrusions and holes. The frame #10, on which the winding is done, may be manufactured of various materials, including materials with good magnetic conductivity. To reduce reactance, instead of one coil, several are wound and connected in parallel. Due to the implementation of the magnetic core without gaps, the use of the claimed invention increases the efficiency of the electric motor, reduces the number of parts and assembly operations, scales down production size and costs.

The present disclosure relates to electrical engineering and can be used during manufacturing of electric motors with permanent magnets on the rotor. Stator of the electric motor comprises the coil assembly, which is made of one or more paralleled inductance coils of a cylindrical type of winding, and the cylindrical magnetic circuit with the poles, which are located at the upper and lower ends of the coil assembly and are performed by means of folding towards each other in order to ensure alternation of their polarity. Magnetic conductor with the poles is made of the strip of electrical steel that is bent in to the tube, on which the mentioned coil assembly is mounted, the winding of which is performed either on the frame, or directly onto the tube, on both sides of which the poles are arranged in the form of alternating protrusions and depressions, so that the depression on one side is formed opposite to the pole from the other side. Also, the methods for manufacturing the stator are proposed. Embodiments disclosed herein can simplify the manufacturing process and increase efficiency.

What is claimed is:

1. An electric motor stator comprising:
a coil unit comprising one or more cylindrical winding type inductors connected in parallel; and
a cylindrical magnetic core with poles located at the upper and lower ends of the coil unit and bent towards each other to ensure alternating polarity, the cylindrical magnetic core comprising an electrical steel strip bent into a tube on which the specified coil unit is placed, the winding of which done either on the frame or directly on the tube, with poles made on its both sides in the form of alternating protrusions and depressions, so that the depression on one side is formed opposite to the pole from the other side.

2. A method for manufacturing method for electric motor stator, comprising:
a coil assembly comprising one or more cylindrical winding type inductors connected in parallel, and a cylindrical magnetic core with poles that are located on the upper and lower ends of the coil assembly and are made by bending towards each other, different in that the magnetic core with poles is made from a blank in the form of an electrical steel strip, on both sides of which poles are cut in the form of alternating protrusions and depressions, so that the depression on one side is formed opposite to the pole from the other side, then the blank is bent into a tube, which is mounted on the coil assembly wound on the frame, then the magnetic poles are bent towards each other.

3. Manufacturing method for electric motor stator, comprising:
a coil assembly comprising one or more cylindrical winding type inductors connected in parallel, a cylindrical magnetic core with poles that are located on the upper and lower ends of the coil assembly and are made by bending towards each other, different in that the magnetic core with poles is made from a blank in the form of electrical steel strip, on both sides of which poles are cut in the form of alternating protrusions and depressions, so that the depression on one side is formed opposite to the pole from the other side, then the blank is bent into a tube, the poles of the magnetic core are bent towards each other, then the coil assembly is wound onto a cylindrical magnetic core, and the poles are again bent.
